(19) United States
(12) Patent Application Publication
(10) Pub. No.: US 2005/0184706 A1
(43) Pub. Date: Aug. 25, 2005

(54) Hybrid capacitor module for car audio system

(76) Inventor: Liao-Tai Tsai, Taipei (TW)

Correspondence Address: HARNESS, DICKEY & PIERCE, P.L.C., P.O. BOX 8910, RESTON, VA, 20195, US

(21) Appl. No.: 10/873,128

(22) Filed: Jun. 23, 2004

(30) Foreign Application Priority Data
Feb. 20, 2004 (TW) 93202490

(51) Int. Cl. H02J 1/00

(52) U.S. Cl. 320/166

(57) ABSTRACT

A hybrid capacitor module is provided for car audio systems. The module comprises plural ultra-capacitors connected in series and one or more electronic foil capacitor connected to the ultra-capacitors in parallel. With both high capacity of the ultra-capacitors and low ESR (Equivalent Series Resistance) of the electronic foil capacitor, the module is capable of discharging high electricity in shorter response time. When the car audio system needs to transmit a bass peak, enough peak power is provided instantaneously by the module to achieve a shorter bass response time and better bass output performance.

### BACKGROUND OF THE INVENTION

1. Field of Invention

The present invention pertains to a capacitor module applied to car audio systems and particularly to a hybrid capacitor module combining ultra-capacitors and one or more electronic foil capacitors.

2. Related Art

Generally, when the audio systems of vehicles, such as automobiles, need to deliver instantaneous bass peak, the related power supply system is not capable of providing enough power. Because the voltage of the systems is decreasing to a critical point (the amplifier can not produce rated output power), a clip of the amplifier is then generated and causes distortion or damage of speakers. Therefore, capacitors are necessary for car audio systems for storage and to provide adequate electronic power.

FIG. 1 shows a power supply system in the prior art, which comprises electronic foil capacitors such as electronic aluminum foil capacitors in a car audio system. Electronic foil capacitor 10, 11 and 12 are used to supply power toward 3 amplifiers respectively. However, the bass output performance of this system is not satisfying due to the electronic property limitation of electronic foil capacitors.

Table 1 illustrates the performance comparisons between a lead acid battery, an ultra-capacitor such as carbon capacitor cell and EDLC (electric double layer capacitor), and an electronic foil capacitor. The charge time and the discharge time of the lead acid battery is much longer than the charge and discharge time of the ultra-capacitor and electronic foil capacitor, so the lead acid battery is not qualified to serve as a power source of car audio systems. There is a direct correlation between charge/discharge time and ESR (Equivalent Series Resistance). The electronic foil capacitor can charge/discharge in a very short time because of its low ESR. However, the capacity in unit volume of the electronic foil capacitor is far less than the capacity of the ultra-capacitor. The electronic foil capacitor is too big to arrange in the tight space of a car vehicle. In addition, the electronic foil capacitor is much more expensive than an ultra-capacitor with the same capacitance.

However, the ultra-capacitor is not perfect for everything. As shown in Table 1, the charge/discharge time of the ultra-capacitor is 102-107 times longer than the charge/discharge time of the electronic foil capacitor. Which means, with the same capacitance, the bass performance of the ultra-capacitor is worse than the bass performance of the electronic foil capacitor because the bass response of the ultra-capacitor is not fast enough when a bass peak occurs. Consequently, slow bass response causes a delay of the bass peak.

Another common problem in a car sound system is that the alternating current generated by the vehicle's alternator causes noise, also known as “alternator whine”. Conventional power supply arrangement in a car audio system cannot filter the noise.

TABLE 1
Performance comparisons between various
electric energy storage devices

| | Lead | | | | Electronic | |
|---|---|---|---|---|---|---|
| Performance | Acid Battery | | Ultra-capacitor | | Foil Capacitor | |
| Charge Time | 1-5 | hr | 0.3-32 | sec | 10⁻³-10⁻⁶ | sec |
| Discharge | 0.3-3 | hr | 0.3-32 | sec | 10⁻³-10⁻⁶ | sec |
| time | | | | | | |
| Energy | 10-100 | Wh/kg | 1-10 | Wh/kg | <0.1 | Wh/kg |
| Cycle Life | 1,000 | | >50,000 | | >500,000 | |
| ESR | >0.1 | Ω | 15-100 | mΩ | <0.1 | mΩ |

### SUMMARY OF THE INVENTION

In response to the aforementioned problems in the prior art, the present invention is to provide a hybrid capacitor module, suitable for car audio systems. With combination of an electronic foil capacitor and an ultra-capacitor in the module, a power source having properties of high energy and fast charge/discharge is provided to achieve faster bass response and better bass output performance.

The hybrid capacitor module provided by the present invention is connected to amplifiers of a car audio system. The module comprises at least an electronic foil capacitor and plural ultra-capacitors. The electronic foil capacitor has properties of relative low ESR (Equivalent Series Resistance) and a relatively short charge/discharge time. The ultra-capacitors have relatively high capacitance. First, the ultra-capacitors are connected to each other in series, and then connected to the electronic foil capacitor in parallel. When the car audio system needs to deliver an instantaneous bass peak, the electronic foil capacitor and the ultra-capacitors connected in parallel are capable of providing enough electric energy to the amplifier to produce rated output power.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will be fully understood from the detailed description given hereinbelow for illustration only, and thus are not limitative of the present invention, and wherein:

FIG. 1 illustrates a portion of a power supply arrangement of a car audio system in the prior art.

FIG. 2 is a vertical view illustrating a hybrid capacitor module according to an embodiment of the present invention.

FIG. 3 shows a portion of a schematic circuit arrangement according to the embodiment, wherein the ultra-capacitors, first connected to each other in series, are connected to the electronic foil capacitors.

FIG. 4 is a schematic view from another side of the module in FIG. 2, wherein the fuse blocks are removed.

FIG. 5 shows a schematic circuit arrangement according to the embodiment while being applied to a car audio system.

FIG. 6 is a schematic view of a hybrid capacitor module in another embodiment, wherein the fuse blocks are also removed.

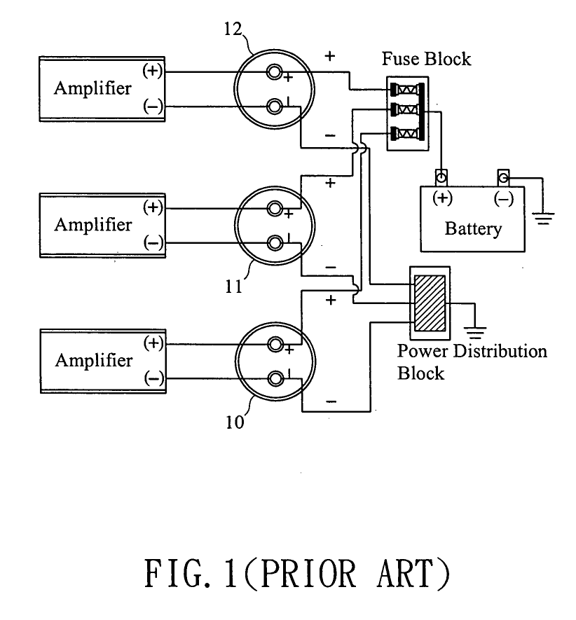

### DETAILED DESCRIPTION OF THE INVENTION

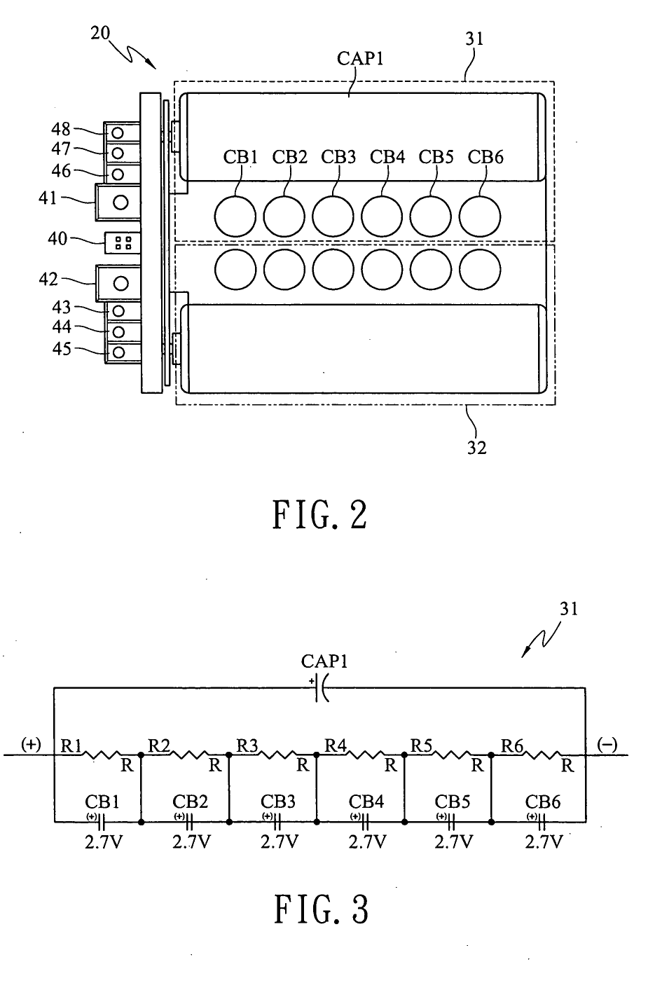

Please refer to FIG. 2, an embodiment of the present invention provides an energy storage device 20 for a car audio system. The energy storage device 20 comprises two hybrid capacitor modules 31 and 32, and several fuse blocks 40, 41, 42, 43, 44, 45, 46, 47 and 48.

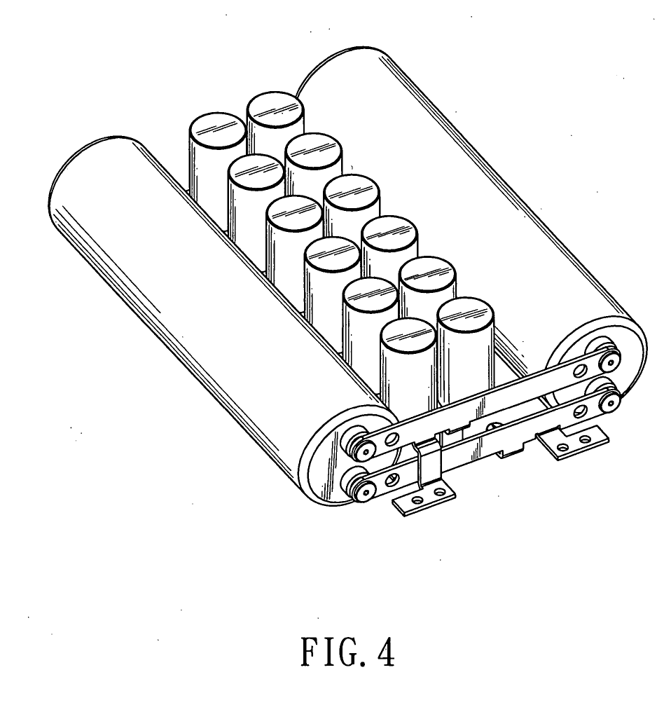

Refer to FIG. 2-4, because the hybrid capacitor modules 31 and 32 are the same, only the hybrid capacitor module 31 is sampled for description in FIG. 3. FIG. 4 is a schematic view from another side of the module in FIG. 2, wherein the fuse blocks are removed. In FIG. 3, the hybrid capacitor module 31 comprises an electronic foil capacitor CAP1, 6 ultra-capacitors CB1, CB2, CB3, CB4, CB5 and CB6, and 6 balance resistances R1, R2, R3, R4, R5 and R6. Each of the balance resistances R1, R2, R3, R4, R5 and R6 has a specific resistance value R. First, each of the ultra-capacitors CB1, CB2, CB3, CB4, CB5 and CB6 connect to the balance resistances R1, R2, R3, R4, R5 and R6 in parallel respectively. Next, the ultra-capacitors CB1, CB2, CB3, CB4, CB5 and CB6 connect to each other in series. Then the ultra-capacitors CB1, CB2, CB3, CB4, CB5 and CB6, already connected in series, connect with the electronic foil capacitor CAP1.

In this embodiment, the electronic foil capacitor CAP1 is an electronic aluminum foil capacitor, which has a specification of 16 V and 0.5 F. An electronic aluminum foil capacitor has a relative lower ESR in comparison with an ultra-capacitor. Therefore, the electronic foil capacitor CAP1 has shorter charge/discharge time. The defect of small storage capacity of the electronic foil capacitor CAP1 can be supplemented by the ultra-capacitors CB1, CB2, CB3, CB4, CB5 and CB6. The ultra-capacitors used in the embodiment are optional. Both carbon capacitor cells or EDLCs (Electric Double Layer Capacitor), with 2.7 V and 100 F in this embodiment, serve the hybrid capacitor module as well. Although the ultra-capacitors CB1, CB2, CB3, CB4, CB5 and CB6 have a higher ESR, the overall ESR can be decreased to several mΩs via connection with the electronic foil capacitor CAP1 in parallel. The balance resistances R1, R2, R3, R4, R5 and R6 are to make a same overall voltage of 16 V as the electronic foil capacitor CAP1. Also, when any of the ultra-capacitors is not functioning, the balance resistance connected in parallel serves as a substitute circuit. But practically, they are not a must.

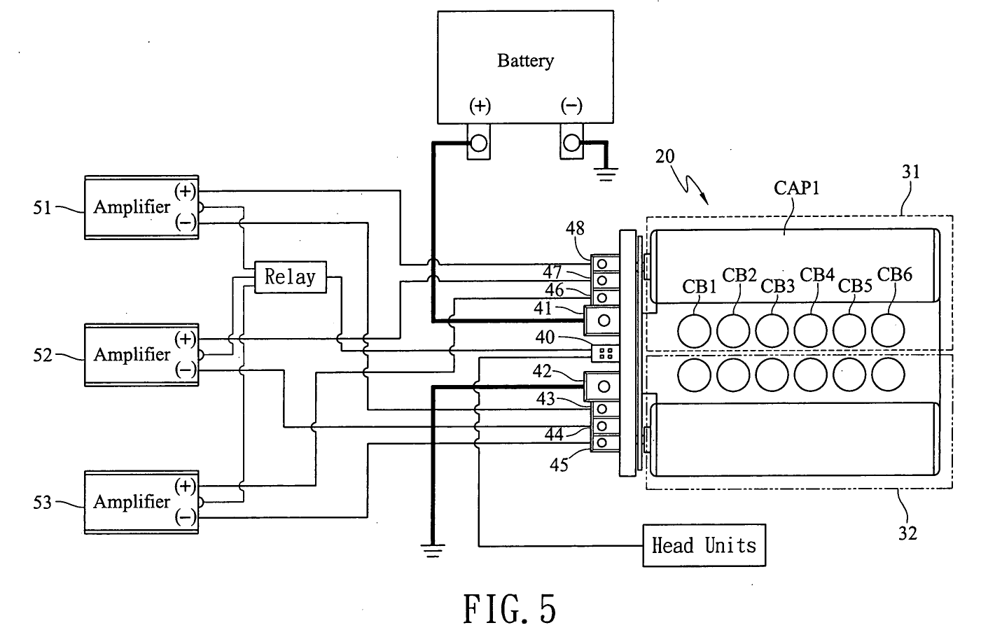

In FIG. 5, after first being connected with the fuse blocks 40, 41, 42, 43, 44, 45, 46, 47 and 48, the hybrid capacitor modules 31 and 32 are connected indirectly to a battery, 3 amplifiers 50, 51 and 52, and head units in a car audio system. When a bass peak occurs, the hybrid capacitor modules can deliver enough peak power (provided by the ultra-capacitors) in a very short time (via the electronic foil capacitor). Besides, the modules provide back power when the overall voltage of the audio system is too low. Therefore, the modules supplement the overall voltage and prevent the amplifiers from clipping. And damage of speakers will be no longer caused by power supply problems. In addition, the “alternator whine” caused by the alternating current (generated from the vehicle's alternator) is found reduced or eliminated in most cases of using the hybrid capacitor modules according to the present invention.

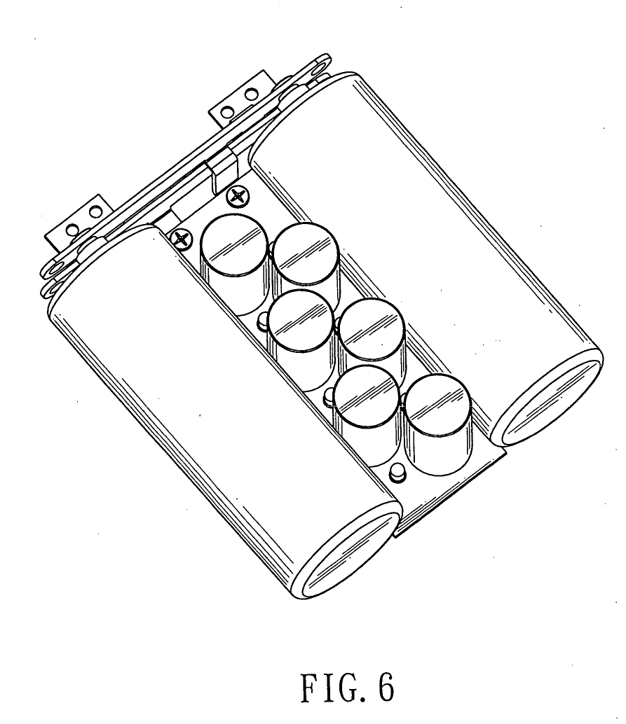

In the foregoing embodiment, the energy storage device combines two sets of hybrid capacitor modules, each having one electronic foil capacitor of 16 V, 0.5 F and 6 ultra-capacitors of 2.7 V, 100 F. However, the arrangement and specifications of said capacitor cells are not limitations of the present invention. According to different practical situations, the present invention is suitable for energy storage devices combined with various hybrid capacitor modules. For example, another type of energy storage device showing in FIG. 6, which has 2 electronic foil capacitors and 6 ultra-capacitors, can serve in a specific power supply system as well.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A hybrid capacitor module connected to at least a amplifier of a car audio system, comprising:
at least a electronic foil capacitor with properties of relatively low ESR (Equivalent Series Resistance) and relatively short charge/discharge time; and
a plurality of ultra-capacitors with relatively high capacitance first being connected to each other in series, and then being connected to the electronic foil capacitor in parallel;
wherein the electronic foil capacitor and the ultra-capacitors connected in parallel providing enough electric energy to the amplifier to produce rated output power when the car audio system needs to deliver a instantaneous bass peak.

2. The hybrid capacitor module in claim 1, wherein the electronic foil capacitor is an electronic aluminum foil capacitor.

3. The hybrid capacitor module in claim 1, wherein the ultra-capacitors are carbon capacitor cells or EDLCs (Electric Double Layer Capacitors).
